(19) United States
(12) Patent Application Publication
(10) Pub. No.: US 2013/0251445 A1
(43) Pub. Date: Sep. 26, 2013

(54) COUPLING DEVICE

(71) Applicants: Justin Peter Robertshaw, Hinckley (GB); Gillian Annette Jakes, Atherstone (GB); Philip Benford, Hastings (GB); David Morgan, Hastings (GB)

(72) Inventors: Justin Peter Robertshaw, Hinckley (GB); Gillian Annette Jakes, Atherstone (GB); Philip Benford, Hastings (GB); David Morgan, Hastings (GB)

(73) Assignees: Technical Tunnelling Components, Ltd., St. Leondards on Sea (GB); Bosworth Plastics Limited, Hinckley (GB)

(21) Appl. No.: 13/878,120

(22) PCT Filed: Oct. 5, 2011
(86) PCT No.: PCT/GB11/51900

§ 371 Date: Jun. 3, 2013

(30) Foreign Application Priority Data
Oct. 5, 2010 (GB) 1016689.0
Jun. 16, 2011 (GB) 1110182.1

(51) Int. Cl. F16B 21/08; B29C 45/16

(52) U.S. Cl. CPC F16B 21/08; B29C 45/1671
USPC 403/167; 403/408.1; 403/361; 264/271.1

(57) ABSTRACT

A pin or male member for a coupling device is disclosed. The pin may comprise an elongate non-metallic bar (2) and an elongate metal bar (25). The elongate non-metallic bar (2) has a first end (4), a second end (5), a central portion (9) extending along the elongate non-metallic bar (2), first grooves (7) towards the first end (4), and second grooves (6) towards the second end (5). The elongate metal bar (25) is enclosed in the elongate non-metallic bar (2). The elongate metal bar (25) comprises indents or protrusions, or both, on its surface and the indents or protrusions, or both, engage the elongate non-metallic bar (2).

The technical field of the present invention relates to a coupling device for joining two members. These members may for example be tunnel segments, well segments, building segments, precast concrete members, preformed panels and other items used in but not limited to the construction industry. More particularly, the present invention relates to a coupling device, a pin for a coupling device, a method for producing the pin, the pin and female members of such a coupling device, a male member for a coupling device, and a female member for a coupling device.

In recent years, attention has been given to coupling devices for joining members. Such a device is known from UK patent GB 2367873 and is useful background art for understanding the present disclosure. In this device a strengthening rod may be provided to improve shear, to avoid a break in the coupling's radial direction.

In view of such coupling devices and other coupling devices, there is a need to improve tensile resistance of coupling devices. Axial displacement due to axial pulling forces is desirably minimized. Axial stretch should be kept to a minimum, preferably zero or at least less than a few millimetres, for example five millimetres, over the total length of a coupling device. Tensile resistance of the coupling, especially within the pin, is desirable. In the known device, the pin, the male member, fails when the axial pulling forces become too large. It is desirable to have the cups, the female members, of the coupling to fail rather than the pin. It is desirable that the male and female members fail at the same time, thus have equal strength.

A problem is to provide a coupling device with improved coupling force. A problem is to improve the grip between the male member and the female member of coupling devices. A problem is to provide a coupling device where the male and female members are of similar coupling strength. This could allow the coupling device to have an improved coupling force. Grooves of the male member and grooves of the female member must not be damaged during assembly of the male member into the female member, because this could reduce the coupling force of the coupling device.

Additionally, it is preferential to avoid cumbersome arrangements from a technical and/or economical point of view. Keeping manufacturing costs to a minimum is highly desirable. One may try to achieve an optimum balance between performance, especially coupling force and tensile resistance, and manufacturing costs. It is thus a problem how to improve the coupling and at the same time reducing or minimizing manufacturing costs.

A restriction on this type of coupling devices is that preferably no metal parts should be used when joining the two members. These members may for example be tunnel segments, well segments, building segments, precast concrete members, preformed panels and other items used in but not limited to the construction industry. In other words, a metal coupling or parts will not be considered or used for joining the two members by the industry in this technical field.

It is an object of the present invention to provide a coupling device. This object can be achieved by the features of the independent claims. Further enhancements are characterized in the dependent claims.

One embodiment provides a pin for a coupling device. The pin comprises an elongate non-metallic bar and an elongate metal bar. The elongate non-metallic bar has a first end, a second end, a central portion extending along the elongate non-metallic bar, first grooves towards the first end, and second grooves towards the second end. The elongate metal bar is enclosed in the elongate non-metallic bar. The elongate metal bar comprises indents and/or protrusions on its surface and the indents or protrusions engage the elongate non-metallic bar. This strengthens the pin in its axial direction. This improves the coupling and reduces its manufacturing costs. The elongate metal bar may comprise indents or protrusions on its radial surface and may be totally encased within the elongate non-metallic bar longitudinally along the.

According to one embodiment, a diameter d of the elongate metal bar is in the range of equal to or more than one third of the diameter of the elongate non-metallic bar and equal to or less than fourteen fifteenths of the diameter of the elongate non-metallic bar. According to one embodiment, half the difference between the axial length of the elongate non-metallic bar and the axial length of the elongate metal bar is less than a third of the diameter of the elongate non-metallic bar. According to these two embodiments, separately or together, one may achieve an optimum balance between performance, especially coupling force and tensile resistance, and manufacturing costs. The coupling may be improved and at the same time manufacturing costs may be reduced or minimized. The configuration of the coupling combining different parts such as the elongate metal bar, the elongate non-metallic bar, and even an over-mould may allow improvement of the coupling properties and its manufacturing costs.

According to one embodiment, the diameter D of the elongate non-metallic bar 2 may be 30, 38, or 45 mm and the diameter d of the elongate metal bar 25 may be 12, 20, or 27 mm, respectively. According to one embodiment, the elongate metal bar 25 is an M12, M20, or M27, respectively, preferably with the grades 8.8, 4.6, or 4.6, respectively.

One embodiment provides a pin wherein the indents or protrusions are grooves. These grooves may be threads. According to one embodiment, the elongate metal bar is a threaded metal bar, preferably an M12. However, any M-size from M8 to M30 may be used preferably.

One embodiment provides a pin further comprises an over-mould surrounding a circumference of the elongate non-metallic bar along at least a part of the central portion in the elongation of the elongate non-metallic bar. In one embodiment, the central portion may comprise third grooves and the over-mould may extend into the third grooves. In one embodiment, the central portion may comprise at least two sets of the third grooves. The elongate bar and the over-mould may be made out of different materials. The elongate bar may comprise nylon; preferably extruded nylon. The elongate bar may be extruded and the over-mould may be injection moulded. Axial stretch of the elongate bar may be counteracted by the over-mould extending into the third grooves.

One embodiment provides further a female member of the coupling device. The female member may comprise a first housing having an opening for receiving the pin; a second housing attachable to the first housing; and locking members comprising grooves for engaging with first and second grooves and of an elongate bar, the locking members being flexible and arranged within the first and second housing. The locking members being configured such that the grooves engage deeper with grooves closer to first and second ends of the first and second grooves than with grooves closer to the central portion of the elongate bar. The elongate bar may be the elongate bar disclosed above, or any other suitable elongate bar.

In one embodiment, the configuration of the locking member may be made by arranging grooves that are further away from the opening closer to an axis of symmetry of the female member than grooves that are closer to the opening. Additionally, or alternatively, the configuration of the locking member may be made by causing a higher radial pressure on grooves that are further away from the opening than grooves that are closer to the opening.

In one embodiment, the locking members may be interconnected with each other at one end. The first housing and/or the second housing may comprise indents on the outside.

A method for producing the pin with the overmould may comprise the steps of overmoulding the elongate metal bar with the elongate non-metallic bar to form the pin; and injection-moulding the over-mould onto the elongate bar.

The tensile resistance may be improved with such a coupling device, because the elongate non-metallic bar, the elongate metal bar, and optionally the over-mould work together to resist axial stretch. Hereby axial displacement due to axial pulling forces is minimized. Tensile resistance may be improved, because the elongate non-metallic bar and the elongate metal bar interconnected by indents and/or protrusions.

The coupling device may have a stronger hold/coupling force, because of increased tensile resistance of the device. No breakage or damage occurs to the grooves during assembly, because of the flexible locking members. The coupling force may also improve because the interaction, the engagement, between the grooves of the male and female members is improved. This may allow the use of a gasket for high pressure between two elements that should be coupled. Further, a better grip between the female member and an element may be achieved, because of external indents on the female member. The coupling device is very well suited for aligning and coupling elements, because of a conical shape of the over-mould.

The coupling device may be inexpensive to manufacture, because the elongate non-metallic bar and the elongate metal bar together form an inexpensive pin compared with a pin comprised only of a non-metallic bar. It is thus the combination of different materials that allow an inexpensive manufacture. The ratio, the relationship, between the elongate non-metallic bar and the elongate metal bar also contributes to this inexpensive manufacturing and/or to the strength of the pin and the coupling.

One embodiment provides a male member for a coupling device. The coupling device may comprise a female member. The male member may comprise an elongate bar having a first end, a second end, and a central portion extending along the elongate bar; first grooves towards the first end; second grooves towards the second end; and an over-mould surrounding a circumference of the elongate bar along at least a part of the central portion in the elongation of the elongate bar. The central portion may comprise third grooves and the over-mould may extend into the third grooves.

In one embodiment, the central portion may comprise at least two sets of the third grooves. The elongate bar and the over-mould may be made out of different materials. The elongate bar may comprise nylon; preferably extruded nylon. The elongate bar may be extruded and the over-mould may be injection moulded. Axial stretch of the elongate bar may be counteracted by the over-mould extending into the third grooves.

One embodiment provides a female member for a coupling device. The coupling device may comprise a male member. The female member may comprise a first housing having an opening for receiving the elongate bar; a second housing attachable to the first housing; and locking members comprising grooves for engaging with first and second grooves and of an elongate bar, the locking members being flexible and arranged within the first and second housing. The locking members being configured such that the grooves engage deeper with grooves closer to first and second ends of the first and second grooves than with grooves closer to the central portion of the elongate bar. The elongate bar may be the elongate bar disclosed above, or any other suitable elongate bar.

In one embodiment, the configuration of the locking member may be made by arranging grooves that are further away from the opening closer to an axis of symmetry of the female member than grooves that are closer to the opening. Additionally, or alternatively, the configuration of the locking member may be made by causing a higher radial pressure on grooves that are further away from the opening than grooves that are closer to the opening.

In one embodiment, the locking members may be interconnected with each other at one end. The first housing and/or the second housing may comprise indents on the outside.

One embodiment provides a coupling device comprising a combination of such a male member and one or two of such a female member.

A method for producing such a male member may comprise the steps of first extruding the elongate bar from nylon, and secondly injection moulding the over-mould onto the elongate bar.

The tensile resistance may be improved with such a coupling device, because the elongate bar and the over-mould work together to resist axial stretch. Hereby axial displacement due to axial pulling forces is minimized. Tensile resistance may be improved, because the elongate bar and over-mould are interconnected by grooves.

The coupling device may have a stronger hold/coupling force, because of increased tensile resistance of the device. No breakage or damage occurs to the grooves during assembly, because of the flexible locking members. The coupling force may also improve because the interaction, the engagement, between the grooves of the male and female members is improved. This may allow the use of a gasket for high pressure between two elements that should be coupled. Further, a better grip between the female member and an element may be achieved, because of external indents on the female member. The coupling device is very well suited for aligning and coupling elements, because of a conical shape of the over-mould.

The coupling device may be inexpensive, because the elongate bar and the over-mould may be made out of different materials. For example, the elongate bar may be made of extruded nylon, while the over-mould may be of a less expensive material.

Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any preceding claimed embodiment(s). The pin mentioned above may be the same as the male member and vice versa. In the industry, the pin may be referred to as a male member and the female member may be referred to as a socket.

The accompanying drawings, which are incorporated in and constitute a part of the specification, illustrate presently preferred exemplary embodiments of the invention, and together with the general description given above and the detailed description of the preferred embodiments given below, serve to explain, by way of example, the principles of the invention.

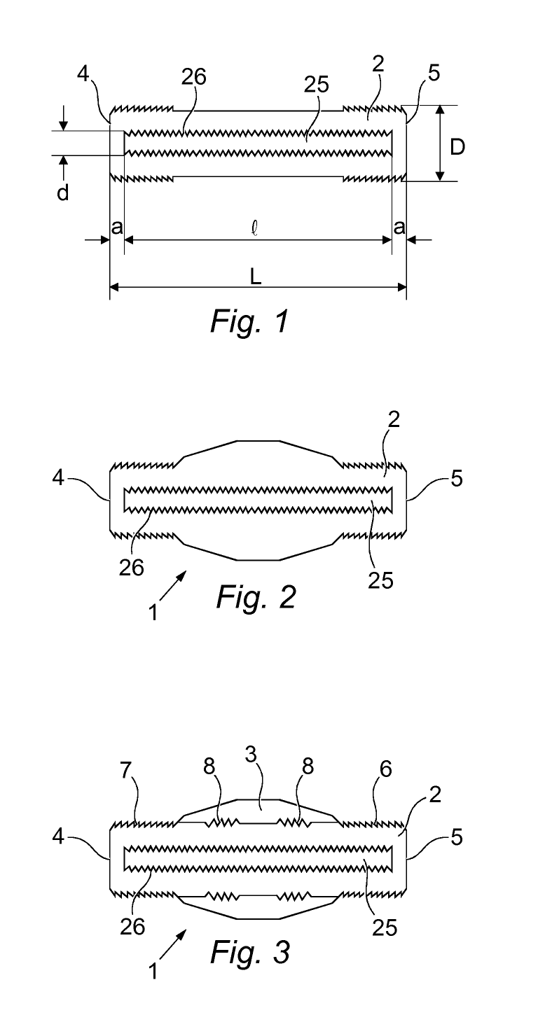

FIG. 1 shows an exemplary embodiment of a pin or male member.

FIG. 2 shows an exemplary embodiment of a pin or male member.

FIG. 3 shows an exemplary embodiment of a pin or male member with an over-mould.

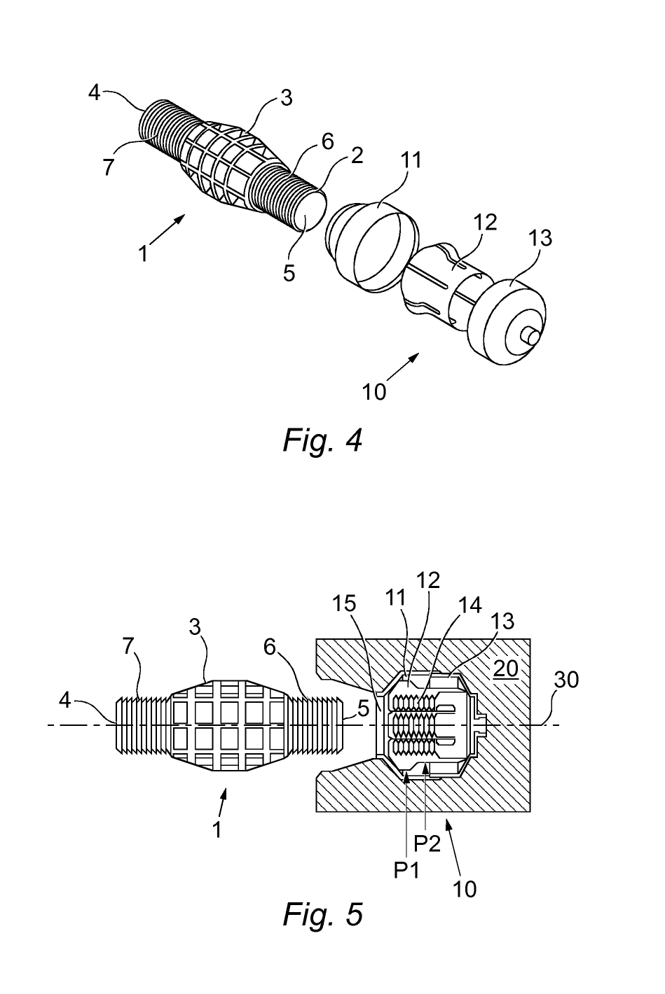

FIG. 4 shows an exemplary embodiment of a coupling device.

FIG. 5 shows an exemplary embodiment of a male member (pin) and female member (socket).

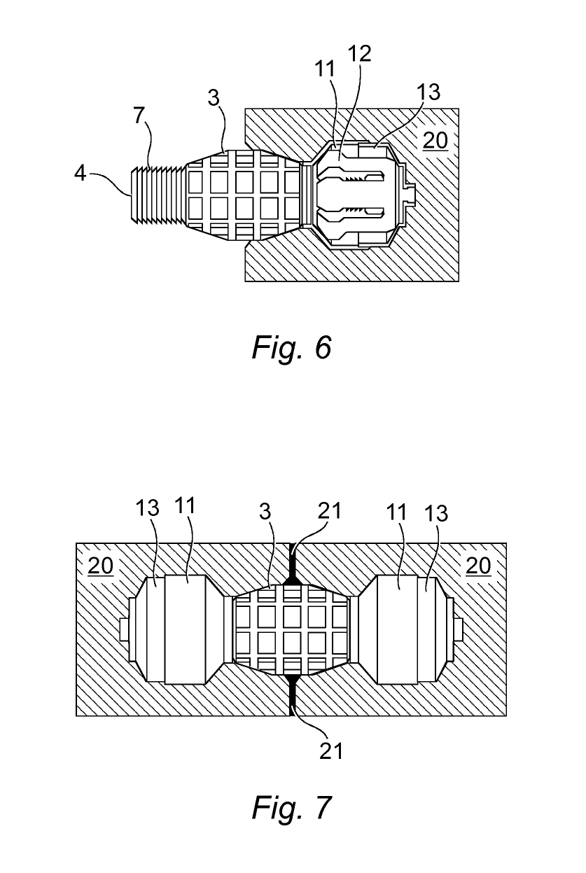

FIG. 6 shows an exemplary embodiment of a male member (pin) and female member (socket).

FIG. 7 shows an exemplary embodiment of a male member (pin) and two female members (sockets).

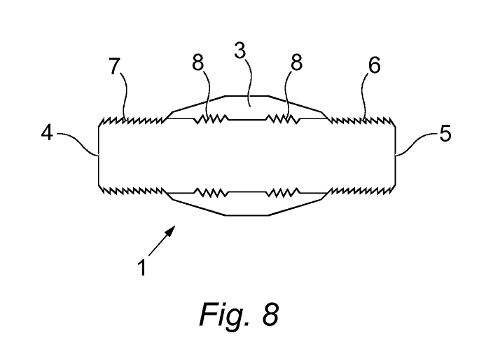

FIG. 8 shows an exemplary embodiment of a pin or male member.

It is to be understood that wherever reference is made in this disclosure to a member, the present coupler devices are also intended to be used with any fixing requirement, or fixing equipment.

FIG. 1 illustrates an exemplary embodiment of a pin or male member. The pin comprises an elongate non-metallic bar 2 and an elongate metal bar 25. The elongate metal bar 25 is completely enclosed by the elongate non-metallic bar 2 and therefore do not expose the metal to the environment. Hereby the inclusion of metal in the coupling may be acceptable to the industry.

The elongate non-metallic bar 2 has a first end 4, a second end 5, a central portion 9 extending along the elongate non-metallic bar 2, first grooves 7 towards the first end 4, and second grooves 6 towards the second end 5. The elongate metal bar 25 is enclosed in the elongate non-metallic bar 2. The pin comprises thus at least two parts, the elongate non-metallic bar 2 and the elongate metal bar 25.

The elongate metal bar 25 comprises indents and/or protrusions 26 on its surface. The indents and/or protrusions 26 are on the radial surface rather than the axial surface of the elongate metal bar 25. The indents and/or protrusions 26 engage the elongate non-metallic bar 2. This engagement may be achieved by the elongate non-metallic bar 2 being moulded over the elongate metal bar 25. The indents and/or protrusions 26 may take the form of grooves. The indents and/or protrusions 26 may take the form of threads. In one embodiment the elongate metal bar 25 may be an M12.

However, any M-size from M8 to M30 may be used preferably. The use of an M-sized metal bar renders the manufacturing costs of the pin inexpensive while at the same time achieves a strong pin for the coupling.

According to one embodiment, a diameter d of the elongate metal bar 25 may be in the range of equal to or more than one third of the diameter D of the elongate non-metallic bar 2 and equal to or less than fourteen fifteenths of the diameter D of the elongate non-metallic bar 2. Written differently this corresponds to ⅓D≦d≧ 14/15D.

According to one embodiment, half the difference between the axial length L of the elongate non-metallic bar 2 and the axial length I of the elongate metal bar 25 is less than a third of the diameter D of the elongate non-metallic bar 2. Written differently this corresponds to ½(L-I)<⅓D. With reference to FIG. 1, half the difference between the axial length L of the elongate non-metallic bar 2 and the axial length I of the elongate metal bar 25 is indicated as the length a. Thus, a<⅓D. This relationship allows for a strong pin. If the elongate metal bar 25 is too short, then problems of pin failure may occur. If the elongate metal bar 25 is too long, then problems with manufacturing and expenses of the pin may occur.

According to these two embodiments, separately or together, one may achieve an optimum balance between performance, especially coupling force and tensile resistance, and manufacturing costs when the pin is dimensioned and manufactured according to the above given ranges. The coupling may be improved and at the same time manufacturing costs may be reduced or minimized. The configuration of the coupling combining different parts such as the elongate metal bar, the elongate non-metallic bar, and if desired even an over-mould may allow improvement of the coupling properties and its manufacturing costs.

Additionally, the relationship of the diameter D of the elongate non-metal bar 2 and the diameter d of the elongate metal bar 25 must be correct to render the pin, the male member, the right properties. A too thin layer of the elongate non-metal bar 2 around the elongate metal bar 25 does not give the right properties. Likewise, a too thick layer of the elongate non-metal bar 2 around the elongate metal bar 25 does not give the right properties.

The following three embodiments provide an especially strong pin which is inexpensive to manufacture. The use of this pin in these three embodiments provides no failure between the elongate metal bar and the elongate non-metallic bar and its grooves to which a female member may be attached.

According to one embodiment, if the diameter D of the elongate non-metal bar 2 is 30 mm, then the use of an M12 as the elongate metal bar 25 (the diameter d of the elongate metal bar 25 is 12 mm and threaded), may provide an especially strong pin which is inexpensive to manufacture. The use of a grade 8.8 (property class according to ISO 898) M12, may provide an especially inexpensive and even stronger pin. This relationship of these two diameters D and d achieves no failure of the pin when the pin is subjected to an axial force. For example, the non-metal bar 2 maintains grip with the indents and/or protrusions 26 of the elongate metal bar 25 and a female member 10 when subjected to large axial forces. While prior couplings fail due to pin failure, pins according to the above embodiments do not fail. Instead failure of the coupling may occur in female members coupled to such pins.

According to one embodiment, if the diameter D of the elongate non-metal bar 2 is 38 mm, then the use of an M20, preferably grade 4.6, as the elongate metal bar 25, will provide an especially strong pin which is inexpensive to manufacture. According to one embodiment, if the diameter D of the elongate non-metal bar 2 is 45 mm, then the use of an M27, preferably grade 4.6, as the elongate metal bar 25, will provide an especially strong pin which is inexpensive to manufacture. This relationship of these two diameters D and d achieves no failure of the pin when the pin is subjected to an axial force. For example, the non-metal bar 2 maintains grip with the indents and/or protrusions 26 of the elongate metal bar 25 and a female member 10 when subjected to large axial forces. For example, the use of an M16 for the diameter D of 38 mm may cause pin failure. While prior couplings fail due to pin failure, pins according to the above embodiments do not fail. Instead failure of the coupling may occur in female members coupled to such pins. Therefore an improved female member, compared with the mentioned prior art, is disclosed below.

One embodiment provides a pin wherein the indents and/or protrusions are grooves. These grooves may be threads. As described above, any suitable M-size may be used depending on the diameter of the pin.

According to one embodiment, more than one elongate metal bar 25 may be used within the pin. Such an embodiment may further optimize manufacturing costs and coupling forces for couplings, especially for a coupling with a pin with a large diameter.

Turning to FIGS. 2 and 3, the pin may comprise an over-mould 3. The over-mould 3 aids in positioning two units or members 20 relative to each other when they are coupled by the coupling. The over-mould 3 may be an integrated part of the elongate non-metallic bar 2 and may be of the same material as illustrated by FIG. 2. The over-mould 3 may be of a different material and moulded separately over the pin, as illustrated in FIG. 3. Hereby a different material may be used for the over-mould 3. The elongate metal bar 25 is enclosed in the elongate non-metallic bar 2. By manufacturing the pin of two or three different materials as disclosed above an inexpensive and very strong pin may be manufactured. As shown in FIG. 8 the non-metallic bar 2 may be an elongate member without the elongate metal bar 25 enclosed.

FIG. 4 illustrates an exemplary embodiment of a coupling device. Such a coupling device may comprise a pin (male member) 1 connectable with one or two female members (sockets) 10.

The pin 1, the male member 1, comprises an elongate non-metallic bar 2 with an elongate metal bar 25 inside and an over-mould 3 as disclosed above. The pin 1 may be double ended, comprising a first end 5 and a second end 4 and a central portion 9 between the first end 5 and the second end 4. The elongate non-metallic bar 2 may have an o-profile, or any other profile, such as for example a square profile or any other polygonal profile. A cylindrical profile is a preferred embodiment. The pin 1 comprises first grooves 6 around its circumference at the first end 5 and second grooves 7 around its circumference at the second end 4. The first and second grooves 6 and 7 may be a series of grooves. The first grooves 6 may extend over an area of the circumference of the elongate bar 2 from the first end 5 to where the over-mould 3 is located on the elongate bar 2. The area may be larger or smaller, and the illustrated area of grooves 6 in FIG. 4 is only one example. Similar, the second grooves 7 may extend over an area of the circumference of the elongate bar 2 from the second end 4 to where the over-mould 3 is located on the elongate bar 2. The area may be larger or smaller, and the illustrated area of grooves 7 in FIG. 4 is only one example. The central portion 9 may extend along the elongate bar 2 from the first grooves 6 to the second grooves 7.

As illustrated in FIG. 3, the elongate non-metallic bar 2 may comprise third grooves 8 along the central portion 9 of the elongate non-metallic bar 2. The third grooves 8 may extend over an area of the circumference of the elongate non-metallic bar 2 from the first grooves 6 to the second grooves 7 on the elongate non-metallic bar 2. The area may be larger or smaller, and the illustrated area of the third grooves 8 in FIG. 3 is only one example. The third grooves 8 may extend over the entire central portion 9 or only along one or more parts thereof.

The over-mould 3 surrounds the circumference of the elongate non-metallic bar 2 at the central portion 9 thereof. The over-mould 3 may extend around the elongate non-metallic bar 2 from the first grooves 6 at the first end 5 to the second grooves 7 at the second end 4 of the elongate bar 2. The schematic illustration of the over-mould 3 in FIG. 4 is only an example, and the over-mould 3 may extend over an area that is less or more than the central portion 9.

As may be taken from the FIGS. 2 to 8, the over-mould 3 may be double conical. The schematic illustrations of the double conical over-mould 3 in FIGS. 2 to 8 are only examples, and the over-mould 3 may be of any other suitable form or shape depending on application. For example, the over-mould may have one or more straight portions. The central double conical part may act as a core assisting in aligning the units or members 20 that the coupling device couples. Recesses may be provided to limit flexibility without reducing the shear and tensile capacity of the coupling device.

In one embodiment, the over-mould 3 may surround the circumference of the elongate non-metallic bar 2 along at least a part of the central portion 9 in the elongation of the elongate non-metallic bar 2. The over-mould 3 may extend into the third grooves 8. In this way the over-mould 3 may assist the elongate non-metallic bar 2 to take up axial stretch/play of the coupling device. Pulling forces acting on the elongate non-metallic bar 2 is hereby transformed into acting on both the elongate non-metallic bar 2 and the over-mould 3. As disclosed herein before, the elongate non-metallic bar 2 is further assisted by the elongate metal bar 25. Hereby the holding force of the coupling device is improved.

The third grooves 8 may have a profile that is not symmetric. In one embodiment, one side of the groove may be perpendicular to the axis 30 of the elongate non-metallic bar 2. Preferably, this side of the grove is facing outwards from the middle of the elongate non-metallic bar 2 towards the ends of the elongate non-metallic bar 2. This side could alternatively be angled more or less. Hereby a technical effect of counteracting axial stretch of the elongate non-metallic bar 2 may be achieved when the over-mould 3 extends into the grooves of the elongate bar 2. The first and second grooves 6 and 7 may have a corresponding profile.

In one embodiment, the elongate non-metallic bar 2 may be made out of nylon. The elongate non-metallic bar 2 may be extruded nylon and comprises the elongate metal bar 25. The over-mould 3 may be made by injection moulding onto the elongate non-metallic bar 2. The over-mould 3 may be made of any suitable material. In one embodiment the elongate bar 2 and the over-mould 3 are not made out of the same material. For example, the elongate bar 2 may be made of a first material, such as nylon, while the over-mould 3 may be made of a second material less expensive than the first material. Together with the elongate metal bar 25, this will have the technical effect of a more cost effective coupling device with increased holding force.

FIGS. 5 to 7 illustrate schematically members 20. These members 20 may be any kind of item that may be assembled. The members 20 may for example be building blocks, concrete elements, tunnel segments, precast concrete members, preformed panels, and other items used in but not limited to the construction industry. These members 20 may comprise a seal 21 that seal two members 20 that are coupled together. Such a seal 21 may be a gasket or even a gasket for high pressure. Disclosed embodiments may make the use of high pressure gaskets possible, because the improved holding force of the coupling device. No or minimal displacement between the two members 20 coupled is achieved because of no or minimal axial stretch of the coupling device.

An exemplary embodiment of a female member 10 is illustrated by FIGS. 4 to 7. The female member 10 may comprise a first housing 11 comprising an opening 15 for receiving the pin 1, or the elongate non-metallic bar 2 thereof. The female member 10 may comprise a second housing 13 attachable to the first housing 11. By attaching the first and second housing 11 and 13 the housing of the female member may be formed. The first and/or second housing 11 and 13 may have grooves and/or indents interacting with members 20, improving retention of the first and second housing 11 and 13 within the members 20.

The female member may comprise locking members 12 comprising grooves 14 for interacting with first and second grooves 6 and 7 of a pin 1. The locking members 12 may be flexible and arranged within the first and second housing 11 and 13. This flexibility allows an assembly of male and female members without damaging the engaging grooves. As may best be taken from FIG. 4, the locking members 12 are connected to each other at one end. This end may be the end most distant from the opening 15. In FIG. 4 six locking members 12 have been schematically illustrated. This is only one example and the locking members could be more or less, for example, any suitable number from two to twenty-four. The locking members 12 may be flexible so that when the male member and the female member are assembled interacting grooves are not damaged. Hereby the coupling force of the coupling device is improved.

In one embodiment, the locking members 12 may be configured such that the grooves 14 interact deeper with grooves closer to the first and second ends 4 and 5 of the first and second grooves 6 and 7 than with grooves closer to the central part 9 of the elongate bar 2. Hereby the overall interaction of first and second grooves 6 and 7 with the grooves 14 of the locking members 12 improves and thereby the coupling force of the coupling device is improved. The interaction is the engagement between on one hand the grooves 14 with on the other hand the first and second grooves 6 and 7, respectively. The grooves may be recesses, individual concentric rings, or threads, or discrete recesses. The grooves on the male and female members correspond to each other so that they can engage and couple the male and female members. Each groove may have a profile that is not symmetric. In one embodiment, one side of the first and second grooves 6 and 7 may be perpendicular to the axis 30 of the elongate non-metallic bar 2. Preferably, this side of the grove is facing outwards from the middle of the elongate non-metallic bar 2 towards the ends of the pin 1. This side could alternatively be angled more or less. The grooves 14 of the female member may have a corresponding profile to engage the first and second grooves 6 and 7, respectively. Hereby a technical effect of increasing the coupling between the male and female members may be achieved as well as a stronger coupling.

The engagement between grooves 14 and the first and second grooves 6 and 7 of the pin 1 may be made such that the grooves 14 engage deeper, engage with a smaller tolerance, with grooves closer to the first and second ends 4 and 5 of the first and second grooves 6 and 7 than with grooves closer to the central portion 9 of the pin 1. Such configuration of the locking member 12 may be made by arranging grooves 14 that are further away from the opening 15 closer to an axis 30 of symmetry of the female member than grooves 14 that are closer to the opening 15. The axis 30 of symmetry of the female member is coaxial with an axis 30 of the elongate non-metallic member 2 when the male member engages with a female member. The axis 30 is illustrated in FIG. 2. Alternatively, or additionally, such configuration of the locking member 12 may be made by causing a higher radial pressure P2 on grooves 14 that are further away from the opening 15 than radial pressure P1 on grooves 14 that are closer to the opening 15. In other word, pressure P2 may be larger than pressure P1 in FIG. 2. The pressures P1 and P2 are the pressures with which the grooves 14 are pressed onto the first or second grooves 6 and 7. These pressures and their size may be created and dimensioned by the interaction between the locking members 12 and the first and second housings 11 and 13.

This improved engagement between on one hand the grooves 14 and on the other hand the first and second grooves 6 and 7 may have the technical effect of improving the holding/coupling force of the coupling device. This because all, rather than only a few, of the grooves 14 that engage with grooves of the first or second grooves 6 and 7 do so firmly. This female member in combination with the male member, the pin with the elongate non-metallic bar 2 and the elongate metal bar 25, renders the coupling strong enough for any application within the building industry.

According to at least one embodiment, the male member, the pin, may be produced by overmoulding the elongate metal bar 25 with the elongate non-metallic bar 2 to form the pin 1. Thereafter, the over-mould 3 may be moulded onto the elongate non-metallic bar 2. This will have the technical and economical effect of providing an inexpensive yet strong pin, because such a male member is less expensive than a male member made completely out of nylon. The use of two or three different materials to build up the pin gives these effects.

The coupling device may comprise a combination of one male member 1 and one or two female members 10. Normally one male member 1 couples with two female members 10, one at each end. The female members 10 may be pre-installed in the elements 20. When two elements are going to be coupled and aligned, a male member 1 may be assembled with each female member 10 in the elements 20.

According to one embodiment, the male member 1 comprises an elongate bar 2 without a metal bar 25, but with an over-mould 3. The elongate bar 2 in FIG. 4 may be double ended, comprising a first end 4 and a second end 5 and a central portion 9 between the first end 4 and the second end 5. The elongate bar 2 may have an o-profile, or any other profile, such as for example a square profile or any other polygonal profile. A cylindrical profile is a preferred embodiment. The elongate bar 2 comprises first grooves 6 around its circumference at the first end 4 and second grooves 7 around its circumference at the second end 5. The first and second grooves 6 and 7 may be a series of grooves. The first grooves 6 may extend over an area of the circumference of the elongate bar 2 from the first end 4 to where the over-mould 3 is located on the elongate bar 2. The area may be larger or smaller, and the illustrated area of grooves 6 in FIG. 4 is only one example. Similar, the second grooves 7 may extend over an area of the circumference of the elongate bar 2 from the second end 5 to where the over-mould 3 is located on the elongate bar 2. The area may be larger or smaller, and the illustrated area of grooves 7 in FIG. 4 is only one example. The central portion 9 may extend along the elongate bar 2 from the first grooves 6 to the second grooves 7.

As illustrated in FIG. 8, the elongate bar 2 may comprise third grooves 8 along the central portion 9 of the elongate bar 2. The third grooves 8 may extend over an area of the circumference of the elongate bar 2 from the first grooves 6 to the second grooves 7 on the elongate bar 2. The area may be larger or smaller, and the illustrated area of the third grooves 8 in FIG. 8 is only one example. The third grooves 8 may extend over the entire central portion 9 or only along one or more parts thereof.

The over-mould 3 surrounds the circumference of the elongate bar 2 at the central portion 9 thereof. The over-mould 3 may extend around the elongate bar 2 from the first grooves 6 at the first end 4 to the second grooves 7 at the second end 5 of the elongate bar 2. The schematic illustration of the over-mould 3 in FIG. 4 is only an example, and the over-mould 3 may extend over an area that is less or more than the central portion 9.

In one embodiment, the over-mould 3 may surround the circumference of the elongate bar 2 along at least a part of the central portion 9 in the elongation of the elongate bar 2. The over-mould 3 may extend into the third grooves 8. In this way the over-mould 3 may assist the elongate bar 2 to take up axial stretch/play of the coupling device. Pulling forces acting on the elongate bar 2 is hereby transformed into acting on both the elongate bar 2 and the over-mould 3. Hereby the holding force of the coupling device is improved.

The third grooves 8 may have a profile that is not symmetric. In one embodiment, one side of the groove may be perpendicular to the axis 30 of the elongate bar 2. Preferably, this side of the grove is facing outwards from the middle of the elongate bar 2 towards the ends of the elongate bar 2. This side could alternatively be angled more or less. Hereby a technical effect of counteracting axial stretch of the elongate bar 2 may be achieved when the over-mould 3 extends into the grooves of the elongate bar 2.

In one embodiment, the elongate bar 2 may be made out of nylon. The elongate bar 2 may be extruded nylon. The over-mould 3 may be made by injection moulding onto the elongate bar 2. The over-mould may be made of any suitable material. In one embodiment the elongate bar 2 and the over-mould are not made out of the same material. For example, the elongate bar 2 may be made of a first material, such as nylon, while the over-mould 3 may be made of a second material less expensive than the first material. This will have the technical effect of a more cost effective coupling device with increased holding force.

An exemplary embodiment of a female member 10 is illustrated by FIGS. 4 to 7 and has been disclosed above. The female member 10 may comprise a first housing 11 comprising an opening 15 for receiving the elongate bar 2. The female member can be used with the elongate bar 2 or the non-metallic bar 2. Similar to above, the locking members 12 may be configured such that the grooves 14 interact deeper with grooves closer to the first and second ends 4 and 5 of the first and second grooves 6 and 7 than with grooves closer to the central part 9 of the elongate bar 2. Hereby the overall interaction of first and second grooves 6 and 7 with the grooves 14 of the locking members 12 improves and thereby the coupling force of the coupling device is improved. The interaction is the engagement between on one hand the grooves 14 with on the other hand the first and second grooves 6 and 7, respectively. The grooves may be recesses, individual concentric rings, or threads, or discrete recesses. The grooves on the male and female members correspond to each other so that they can engage and couple the male and female members. Each groove may have a profile that is not symmetric. In one embodiment, one side of the first and second grooves 6 and 7 may be perpendicular to the axis 30 of the elongate bar 2. Preferably, this side of the grove is facing outwards from the middle of the elongate bar 2 towards the ends of the elongate bar 2. This side could alternatively be angled more or less. The grooves 14 of the female member may have a corresponding profile to engage the first and second grooves 6 and 7, respectively. Hereby a technical effect of increasing the coupling between the male and female members may be achieved.

The engagement between grooves 14 and the first and second grooves 6 and 7 of the elongate bar 2 may be made such that the grooves 14 engage deeper, engage with a smaller tolerance, with grooves closer to the first and second ends 4 and 5 of the first and second grooves 6 and 7 than with grooves closer to the central portion 9 of the elongate bar 2. Such configuration of the locking member 12 may be made by arranging grooves 14 that are further away from the opening 15 closer to an axis 30 of symmetry of the female member than grooves 14 that are closer to the opening 15. The axis 30 of symmetry of the female member is coaxial with an axis 30 of the elongate member 2 when the male member engages with a female member. The axis 30 is illustrated in FIG. 5.

Alternatively, or additionally, such configuration of the locking member 12 may be made by causing a higher radial pressure P2 on grooves 14 that are further away from the opening 15 than radial pressure P1 on grooves 14 that are closer to the opening 15. In other word, pressure P2 may be larger than pressure P1 in FIG. 5. The pressures P1 and P2 are the pressures with which the grooves 14 are pressed onto the first or second grooves 6 and 7.

This improved engagement between on one hand the grooves 14 and on the other hand the first and second grooves 6 and 7 may have the technical effect of improving the holding/coupling force of the coupling device. This because all, rather than only a few, of the grooves 14 that engage with grooves of the first or second grooves 6 and 7 do so firmly.

According to at least one embodiment, the male member may be produced by firstly extruding the elongate bar 2 from nylon and secondly injection-moulding the over-mould 3 onto the elongate bar 2. This will have the technical and economical effect of providing an inexpensive yet strong male member, because such a male member is less expensive than a male member made completely out of nylon.

The coupling device may comprise a combination of one male member 1 and one or two female members 10. Normally one male member 1 couples with two female members 10, one at each end. The female members 10 may be pre-installed in the elements 20. When two elements are going to be coupled and aligned, a male member 1 may be assembled with each female member 10 in the elements 20.

In use as members 20 are urged together, the pin, the male part 1 engages in the opening 15 of the socket, the female members 10. The first or second grooves 6 or 7 abuts the grooves 14 of the locking members 12, forcing them radially outwards. The movement of the locking members 12 is resisted elastically which forces the mating grooves 14 to engage the first or second grooves 6 or 7. No breakage or damage occurs during assembly because of this flexibility. The locking members 12 engage surrounding housing 11 and 12, locking the male member 1 of the coupling device into the recesses formed in the sides of the members 20 preventing the male member 1 from being pulled out. Once inserted, the male members 1 can only be removed from a female member 10 with great technical difficulty, if at all.

The system and method discussed above provides a coupling device suitable for joining members with a high coupling force. The pin, the male member, has high tensile resistance with hardly any axial stretch. This pin alone or in combination with the female members, sockets, improves the coupling and reduces its manufacturing costs. The invention, therefore, is well adapted to carry out the objects and attain the ends and advantages mentioned, as well as others inherent therein. While the invention has been described and is defined by reference to particular preferred exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts. The described preferred embodiments of the invention are exemplary only, and are not exhaustive of the scope of the invention. Consequently, the invention is intended to be limited only by the scope of the appended claims, giving full cognizance to equivalents in all respects.

1. A pin for a coupling device, the pin comprising:
an elongate non-metallic bar comprising a first end, a second end, a central portion extending along the elongate non-metallic bar, first grooves towards the first end, and
second grooves towards the second end; and
an elongate metal bar enclosed in the elongate non-metallic bar;
wherein the elongate metal bar comprises at least one of indents or protrusions, on its surface and the at least one of indents or protrusions engage the elongate non-metallic bar.

2. The pin according to claim 1, wherein a diameter of the elongate metal bar is in a range of approximately equal to or more than approximately one third of a diameter of the elongate non-metallic bar and approximately equal to or less than approximately fourteen fifteenths of the diameter of the elongate non-metallic bar.

3. The pin according to claim 1, wherein approximately half a difference between an axial length of the elongate non-metallic bar and an axial length of the elongate metal bar is less than approximately one third of the diameter of the elongate non-metallic bar.

4. The pin according to claim 1, wherein the diameter of the elongate non-metallic bar is approximately 30, 38, or 45 mm and the diameter d of the elongate metal bar is approximately 12, 20, or 27 mm, respectively.

5. The pin according to claim 4, wherein the elongate metal bar is M12, M20, or M27, respectively, preferably with grades 8.8, 4.6, or 4.6, respectively.

6. The pin according to claim 1, wherein the at least one of indents or protrusions are grooves.

7. The pin according to claim 1, wherein the elongate metal bar is a threaded metal bar, preferably an M12.

8. The pin according to claim 1, comprising an over-mould surrounding a circumference of the elongate non-metallic bar along at least a part of the central portion in an elongation of the elongate non-metallic bar.

9. The pin according to claim 8, wherein:
the central portion comprises third grooves; and
the over-mould extends into the third grooves.

10. The pin according to claim 9, wherein the central portion comprises at least two sets of the third grooves.

11. The pin according to claim 8, wherein the elongate non-metallic bar, the elongate metal bar, and the over-mould comprise different materials.

12. A coupling device comprising the pin of claim 1 and a female member comprising:
a first housing comprising an opening for receiving the pin;
a second housing attachable to the first housing; and
locking members comprising grooves for engaging with the first grooves or the second grooves of the elongate bar, the locking members being flexible and arranged within the first housing and the second housing; and
wherein the locking members being configured such that the grooves engage deeper with grooves closer to first and second ends of the first and second grooves than with grooves closer to the central portion of the elongate bar.

13. The female member of claim 12, wherein a configuration of the locking member is made by arranging the grooves that are further away from the opening closer to an axis of symmetry of the female member than the grooves that are closer to the opening.

14. The female member of claim 12, wherein a configuration of the locking member is made by causing a higher radial pressure on the grooves that are further away from the opening than grooves that are closer to the opening.

15. The female member according to claim 12 wherein the locking members are interconnected with each other at one end.

16. The female member according to claim 12, wherein at least one of the first housing and the second housing comprises indents on the outside.

17. A male member for a coupling device comprising a female member, the male member comprising:
an elongate bar comprising a first end, a second end, a central portion extending along the elongate bar, first grooves towards the first end, and second grooves towards the second end; and
an over-mould surrounding a circumference of the elongate bar along at least a part of the central portion 9 in an elongation of the elongate bar;
wherein the central portion comprises third grooves; and
wherein the over-mould extends into the third grooves.

18. The male member according to claim 17, wherein the central portion comprises at least two sets of the third grooves.

19. The male member according to claim 17, wherein the elongate bar and the over-mould comprise different materials.

20. The male member according to claim 17, wherein the elongate bar comprises nylon; preferably extruded nylon.

21. The male member according to claim 17, wherein the elongate bar is an extruded elongate bar and the over-mould is an injection moulded over-mould.

22. A female member for a coupling device comprising a male member, the female member comprising:
a first housing comprising an opening for receiving an elongate bar of the male member;
a second housing attachable to the first housing; and
locking members comprising grooves for engaging with first or second grooves and of the elongate bar, the locking members being flexible and arranged within the first housing and the second housing; and
wherein the locking members being configured such that the grooves 14 engage deeper with grooves closer to first and second ends of the first and second grooves than with grooves closer to the central portion of the elongate bar.

23. The female member of claim 22, wherein a configuration of the locking member is made by arranging the grooves that are further away from the opening closer to an axis of symmetry of the female member than the grooves that are closer to the opening.

24. The female member of claim 22, wherein a configuration of the locking member is made by causing a higher radial pressure on the grooves that are further away from the opening than the grooves that are closer to the opening.

25. The female member according to claim 22, wherein the locking members are interconnected with each other at one end.

26. The female member according to claim 22, wherein at least one of the first housing and the second housing comprise indents on an outside.

27. A coupling device comprising a combination of a pin according to claim 1, and
a female member comprising:
a first housing comprising an opening for receiving the pin;
a second housing attachable to the first housing; and
locking members comprising grooves for engaging with the first grooves or the second grooves of the elongate bar, the locking members being flexible and arranged within the first housing and the second housing; and
wherein the locking members being configured such that the grooves engage deeper with grooves closer to first and second ends of the first and second grooves than with grooves closer to the central portion of the elongate bar.

28. A method for producing the pin according to claim 1, comprising the steps of:
overmoulding the elongate metal bar with the elongate non-metallic bar to form the pin; and
injection-moulding the over-mould onto the elongate bar.
